(19) United States
(12) Patent Application Publication
(10) Pub. No.: US 2010/0110712 A1
(43) Pub. Date: May 6, 2010

(54) LIGHT LENS FOR CAR INTERIOR LIGHTING DEVICE

(75) Inventors: Yasuyuki Ando, Aichi-ken (JP); Yoshifumi Honmatsu, Tokyo (JP); Yutaka Nakanishi, Tokyo (JP); Yasunori Takeda, Tokyo (JP)

Correspondence Address: GANZ LAW, P.C., P O BOX 2200, HILLSBORO, OR, 97123, US

(73) Assignees: Kojima Press Industry Co., Ltd., Aichi-ken (JP); Polymatech Co., Ltd., Tokyo (JP)

(21) Appl. No.: 12/502,070

(22) Filed: Jul. 13, 2009

(30) Foreign Application Priority Data
Oct. 31, 2008 (JP) 2008-281415

(51) Int. Cl. F21V 5/00

(52) U.S. Cl. 362/520

(57) ABSTRACT

A light lens used for a car interior lighting device for transmitting light from a light source therethrough and illuminating the car interior is provided, and the light lens has a transparent light lens body, electrodes that are colored transparent conductive coating films for detecting the capacitance and located on a light source side of the light lens, and an insulative coating film that has almost the same color and transmission rate as the conductive coating films and is located on the periphery of the conductive coating films. With this configuration, the uniform light transmission rate is achieved over the light lens.

### PRIORITY INFORMATION

This application claims priority to Japanese Patent Application No. 2008-281415 filed on Oct. 31, 2008, which is incorporated herein by reference in its entirety.

### BACKGROUND OF THE INVENTION

1. Field of the Invention

The present invention relates to a structure of a light lens used for a car interior lighting device.

2. Description of the Related Art

A car interior lighting device for illuminating the interior of a car is provided on the ceiling of the car. Some of such car interior lighting devices employ a touch switch as a light switch in order to easily light up the interior of the car when it is dark. The touch switch is used to turn a light source for illumination on and off by sensing changes in capacitance between an electrode and the human body. For example, a conventional car interior lighting device, such as the one disclosed in JP 2007-230450 A, adopts a configuration in which a transparent electrode is formed on an inner surface of a light lens by, for example, printing and painting, and the lighting device can be turned on and off by touching the design surface side of the light lens.

Such a transparent electrode has been made of indium oxide such as ITO. However, because indium oxide is expensive and there are issues regarding its exhaustion, a conductive polymer or the like which does not employ indium oxide has started to be used as a substitute material, as disclosed in JP 2007-134293 A.

However, the substitute material for indium oxide such as the conductive polymer is a colored transparent material having a lower light transmission rate than indium oxide. Therefore, when it is used as the material for an electrode to be attached to a light transmissive device such as the light lens, the amount of light transmitted through the electrode portion is reduced and the presence of the electrode may be too visible. Specifically, when two transparent electrodes are arranged inside a single light lens in the car interior lighting device so that different light sources are turned on between the driver side and the passenger side, a certain distance is provided between the electrodes in order to avoid erroneous operation. This causes problems that the presence of the electrodes becomes too visible, resulting in poor appearance.

Accordingly, a purpose of the present invention is to achieve a uniform light transmission rate over the light lens in the car interior lighting device.

### SUMMARY OF THE INVENTION

A light lens used for a car interior lighting device has a transparent light lens body, a colored transparent conductive coating film located on a light source side of the light lens to detect the capacitance, and an insulative coating film having almost the same color and transmission rate as the conductive coating film and located on the periphery of the conductive coating film, and the light lens transmits light from the light resource and illuminates the car interior.

In the light lens according to the present invention, it is also preferable to locate the insulative coating film on the periphery of the conductive coating film with fine gaps in between, locate a transparent sheet, on which the conductive coating film and the insulative coating film are formed, on the light source side of the light lens body, and divide the conductive coating film and locate the divided conductive coating films in a plurality of positions on the light source side of the light lens, while locating the insulative coating between the divided conductive coating films.

The present invention has an advantage of achieving a uniform light transmission rate over the light lens in the car interior lighting device.

### BRIEF DESCRIPTION OF THE DRAWINGS

FIG. 1 is a perspective view showing a car interior lighting device according to an embodiment of the present invention;

FIG. 2 is a cross-section showing the car interior lighting device according to the embodiment of the present invention;

FIG. 3 is a circuit diagram showing a control circuit of the car interior lighting device according to the embodiment of the present invention;

FIG. 4 is a plane view showing electrodes composed of conductive coating films formed on a light lens of the car interior lighting device, and an insulative coating film formed on a gap between the electrodes and on the periphery of the electrodes.

### DESCRIPTION OF THE PREFERRED EMBODIMENT

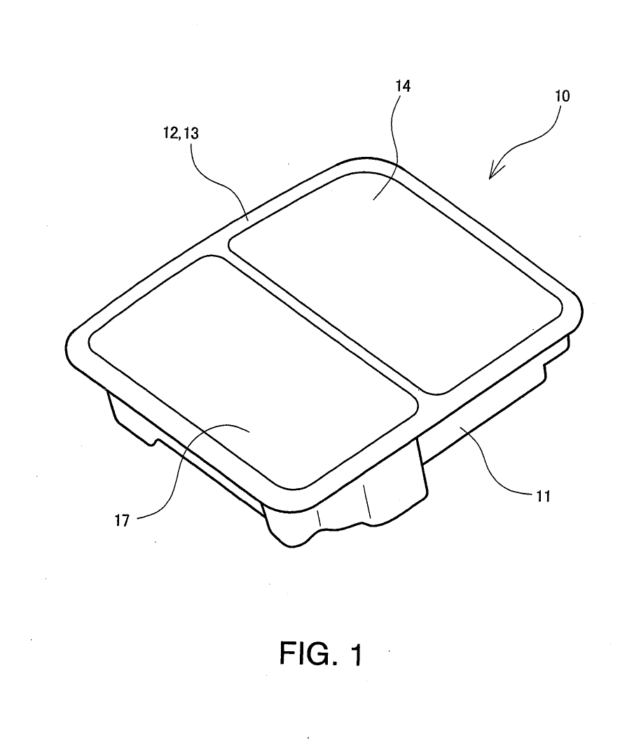

A preferred embodiment of the present invention will be described hereinafter with reference to the drawings. As shown in FIG. 1, a car interior lighting device according to the present embodiment has a case 11 on the ceiling side of a car and a design cover 12 attached to the case 11. The surface of the design cover 12 is refereed to as a design surface 13 and is attached toward the car interior side. A light lens 14 and a change box 7 are attached to the design surface 13 of the design cover 12.

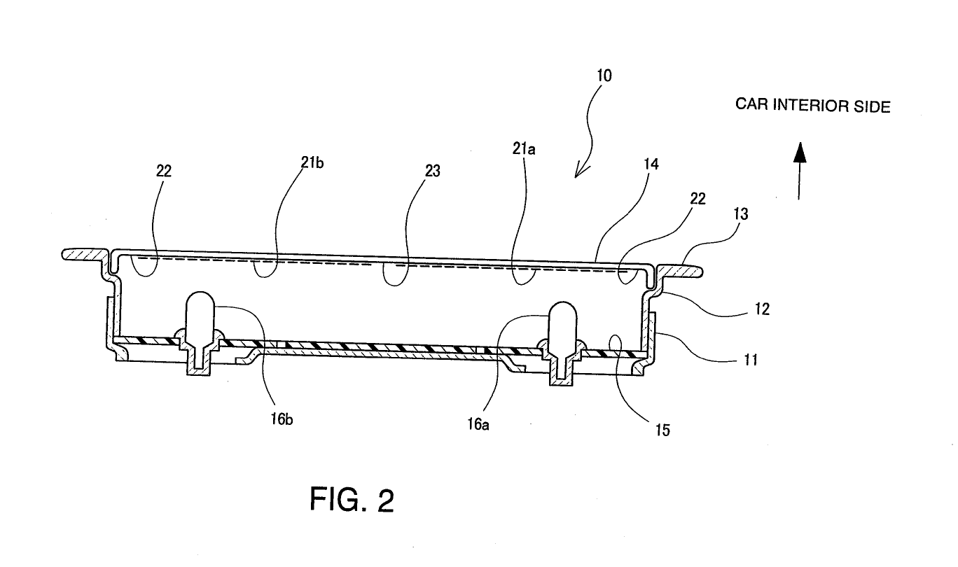

As shown in FIG. 2, an electric circuit board 15 is attached to the bottom portion of the case 11, and bulbs 16a and 16b as light sources for illumination are attached to the electric circuit board 15. The bulb 16a is a bulb for illuminating the driver side while the bulb 16b is a bulb for illuminating the passenger side. A frame of the design cover 12 is fitted into a frame projecting along the circumference of the case 11 so that the case 11 and the design cover 12 are integrally provided.

The design cover 12 has the design surface 13 which is formed on the car interior side so as to match the car interior decoration. Further, a light lens 14 is attached to substantially the same plane as the design surface 13 of the design cover 12. The light lens 14 is configured to transmit the lights from the bulbs 16a and 16b therethrough and guides the light to the driver side and the passenger side, respectively. Electrodes 21a and 21b for detecting the capacitance are formed on the light lens on its surface on the bulbs 16a and 16b side.

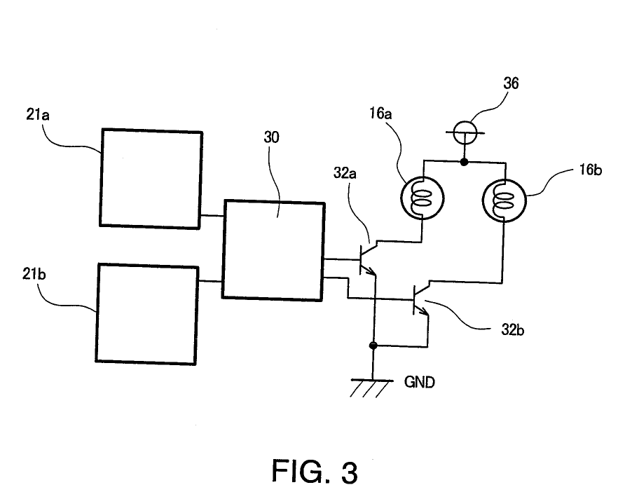

As shown in FIG. 3, the electrodes 21a and 21b are both connected to a control unit 30. The control unit 30 detects changes in stray capacitance between the electrode 21a or the electrode 21b and the human body, and determines if there is contact between them. When the control unit 30 determines that there is contact, the control unit 30 outputs a predetermined output. The outputs from the control unit 30 are connected to gates of bulb drive transistors 32a and 32b for driving the bulbs 16a and 16b, respectively. The anode sides of the bulb drive transistors 32a and 32b are connected to a power supply 36 via the bulbs 16a and 16b, respectively, while the cathode sides are connected to an earth terminal. By switching currents to the gates of the bulb drive transistors 32a and 32b on and off using signals from the control unit 30, the currents from the power supply 36 to the bulbs 16a and 16b are switched on and off. With such a configuration of the control unit 30, the configuration in which the bulb 16a on the driver side is turned on when the driver touches the driver-side surface of the light lens 14, while the bulb 16b on the passenger side is turned on when the passenger touches the passenger-side surface of the light lens 14, is achieved. As shown in FIG. 2, the electrodes 21a and 21b are formed on the light lens on its surface on the bulbs 16a and 16b side with a gap in between, in order to prevent the passenger side bulb 16b from being turned on when the driver side surface is touched.

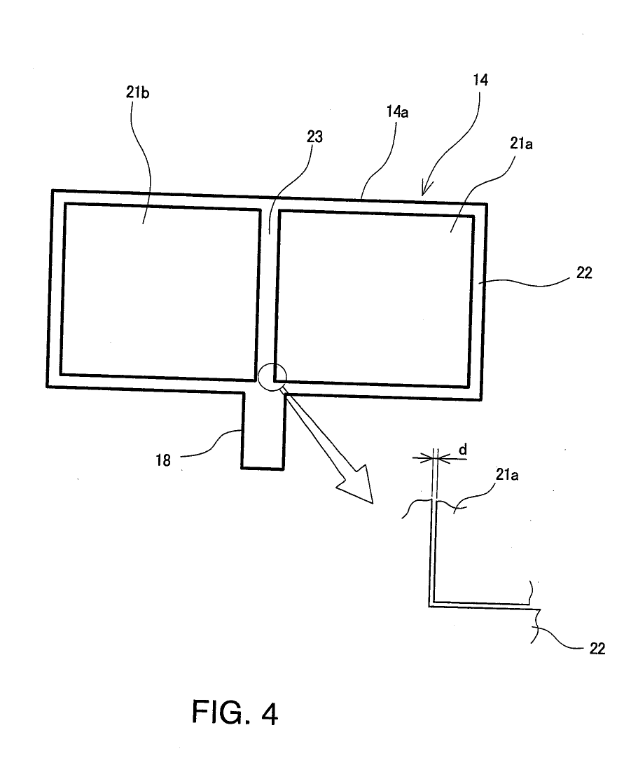

FIG. 4 is a plane view showing the surface of the light lens 14 on which the electrodes 21a and 21b are formed. As shown in FIG. 4, the light lens 14 has a transparent rectangular light lens body 14a fitted into the design surface 13 and a projecting portion 18 connected to the electric circuit board 15. The electrode 21a of the light lens 14 corresponding to the driver side bulb 16a is provided on the light lens body 14a at a region for illuminating the driver side, while the electrode corresponding to the passenger side bulb 16b is provided on the light lens body 14a at a region for illuminating the passenger side. A gap 23 is provided between the electrodes 21a and 21b. The electrodes 21a and 21b are conductive coating films that are formed by applying a conductive coating material on the bulb side surface of the light lens body 14a using screen printing. This conductive coating film is composed of, for example, conductive polymers having a light transmission rate of approximately 50% to 80% and a transparent color such as blue. Conductive polymers include, for example, polyolefin polymers, and, among polyolefin polymers, polyethylenedioxythiophene is preferable in terms of transparency and conductivity. The gap 23 is provided between the electrodes 21a and 21b in order to avoid erroneous operation. Further, because the passenger rarely touches the periphery 22 of the light lens 14a when turning the car interior lighting device 10 on and off, the electrodes 21a and 21b composed of the conductive coating films are not provided on the periphery 22.

As shown in FIG. 4, an insulative coating film is formed on a periphery 22 of the electrodes 21a and 21b and on the gap 23 between the electrodes 21a and 21b. In other words, the insulative coating film is formed on almost the entire lens except for the portions of the bulb side surface on which the electrodes 21a and 21b are formed. Like the conductive coating films constituting the electrodes 21a and 21b, this insulative coating film is formed using screen printing and has the same color and transmission rate as the conductive coating films constituting the electrodes 21a and 21b. After an ink for printing the insulative coating film is used to print the insulative coating film on a transparent plate at a position adjacent to the conductive coating films, the color and the transmission rate of the ink is measured using, for example, a transmissometer, a luxmeter, or a chromameter, and the ink is adjusted so that the color and the transmission rate of the insulative coating film become approximately the same as those of the conductive coating films. Further, because the insulative coating film is formed using screen printing like the conductive coating films constituting the electrodes 21a and 21b, the film thickness of the insulative coating film is approximately the same as the conductive coating film. An ink of vinyl, epoxy, polyester, acrylic, urethane, polyolefin, or the like may be used for the insulative coating film.

As shown in FIG. 4, fine gaps d are provided between the electrodes 21a and 21b composed of the conductive coating films and the periphery 22, and between the electrodes 21a and 21b and the gap 23. These fine gaps d are provided on the grounds that, if the conductive coating material and the insulative coating material are overlapped with each other, the transmission rate of the light passing through that overlapped portion drops significantly, and the overlapped portion becomes too visible as a line when the bulb of the car interior lighting device is turned on, resulting in poor appearance.

The operation of the car interior lighting device 10 having the light lens 14 configured as above will be described. When the driver or the passenger touches the surface of the light lens 14, the bulb 16a or 16b is turned on according to the touched position, and light from the bulb 16a or 16b passes through the electrode 21a or 21b and further passes through the transparent light lens body 14a to illuminate the car interior. Here, the light emitted from the bulb 16a and 16b passes through the colored transparent conductive coating films constituting the electrodes 21a and 21b, respectively. The conductive coating films have a light transmission rate of approximately 50 to 80% and a transparent color such as blue. As such, the light passing through the electrodes 21a and 21b is projected on the car interior as bluish light due to the color of the conductive coating film. Similarly, the light emitted from the bulbs 16a and 16b passes through the insulative coating film on the periphery 22 of the light lens body 14a and on the gap 23 between the electrodes 21a and 21b to be projected on the car interior. The periphery 22 and the gap 23 have the same color and light transmission rate as the electrodes 21a and 21b. For example, when the conductive coating films constituting the electrodes 21a and 21b are transparent blue, the insulative coating film formed on the periphery 22 and the gap 23 is also transparent blue, and the light passing through the insulative coating film also has the same color and luminance as the light passing through the conductive coating films. As such, the light passing through the conductive coating films constituting the electrodes 21a and 21b has the same color and luminance as the light passing through the insulative coating film formed on the periphery 22 and the gap 23. As such, when the car interior lighting device 10 is turned on, the light projected through the conductive coating films constituting the electrodes 21a and 21b and the insulative coating film has the same characteristics. It is therefore possible to prevent the electrodes 21a and 21b from being highly visible from the design side of the light lens 14, thereby improving the appearance of the light lens 14.

Further, the fine gaps d are provided between the conductive coating films constituting the electrodes 21a and 21b and the insulative coating film formed on the periphery 22 and the gap 23. Because these gaps prevent the conductive coating films and the insulative coating film from overlapping with each other, it is possible to avoid the problem that an overlapped portion becomes darker in color and the circumference of the conductive coating films being distinguished from the design surface side of the light lens 14. For example, when this fine gap is made smaller than or equal to approximately 0.2 mm, it is possible to prevent the light passing through a portion that is not the conductive coating film or the insulative conductive coating film from being distinguished from the design surface side of the light lens 14 because of the diffusion effect of the light lens body 14a.

As described above, because the car interior lighting device 10 can achieve substantial uniformity of the color and the light transmission rate of the light over the entire surface of the light lens 14, it is possible to prevent the existence of the electrodes 21a and 21b from being recognized from the design surface side of the light lens 14 and to achieve an advantage of maintaining the appearance of the light lens 14 even when the conductive coating films are composed of the conductive polymer which is the substitute material for indium oxide.

Although in the above-described embodiment the conductive coating films constituting the electrodes 21a and 21b have been formed on the bulb side surface of the transparent light lens body 14a using screen printing, and the insulative coating film has been also formed on the periphery 22 of the light lens body 14a using screen printing, it is also possible to form the conductive coating films constituting the electrodes 21a and 21b on a transparent sheet using, for example, screen printing, painting, coating, and inkjet printing, and form the insulative coating film having the same color and transmission rate as the conductive coating films on the periphery 22 of the sheet using the same method as the conductive coating film, and then attach the sheet on the bulb side surface of the light lens body 14a. Further, it is also possible to print only the conductive coating film on the sheet and print the insulative coating film directly on the lens at the periphery of a position where the sheet is to be located, while conversely, it is also possible to print only the conductive coating film on the lens and print and locate the insulative coating film on the sheet.

Further although the present embodiment has described that the light lens body 14a has the configuration in which the two electrodes 21a and 21b are located separately and the gap 23 is provided therebetween, it is also possible to adopt a configuration in which the conductive coating film constituting one electrode is formed on the light lens body 14a and the insulative coating film having the same color and transmission rate as the conductive coating film is formed on the periphery 22 of the electrode, or a configuration in which the number of the electrodes is not limited to two and may be more than three and the insulative coating film is formed on the gaps 23 between the respective electrodes and on the periphery 22 of the electrodes.

What is claimed is:

1. A light lens used for a car interior lighting device for transmitting light from a light source therethrough and illuminating the car interior, the light lens comprising:
a transparent light lens body;
a colored transparent conductive coating film located on a light source side of the light lens body, for detecting capacitance; and
an insulative coating film that has almost the same color and transmission rate as the conductive coating film and is located on a periphery of the conductive coating film.

2. The light lens according to claim 1, wherein
the insulative coating film is located on the periphery of the conductive coating film with a fine gap in between the insulative coating film and the conductive coating film.

3. The light lens according to claim 1, wherein
a transparent sheet on which the conductive coating film and the insulative coating film are formed is located on the light source side surface of the light lens body.

4. The light lens according to claim 1, wherein:
the conductive coating film is divided and located in a plurality of positions on the light source side of the light lens body; and
the insulative coating film is located among said divided conductive coating films.
